(19) United States
(12) Patent Application Publication
(10) Pub. No.: US 2020/0338838 A1
(43) Pub. Date: Oct. 29, 2020

(54) METHOD FOR PRODUCING A PLASTIC COMPONENT, PLASTIC COMPONENT, AND MACHINING SYSTEM

(71) Applicant: Magna Exteriors GmbH, Sailauf (DE)

(72) Inventor: Marcel MENZEL, Hachenburg (DE)

(21) Appl. No.: 16/955,819

(22) PCT Filed: Nov. 13, 2018
(86) PCT No.: PCT/EP2018/081056

§ 371 Date: Jun. 19, 2020

(30) Foreign Application Priority Data
Dec. 20, 2017 (DE) 10 2017 223 376.1
Jun. 4, 2018 (DE) 10 2017 208 715.6

(51) Int. Cl. B29C 65/00; B29C 71/04; B23K 26/00; B23K 26/382; B23K 26/402; B23K 26/362

(52) U.S. Cl. CPC B29C 66/0246; B29C 66/028; B29C 66/02242; B29C 71/04; B29L 2031/3044; B23K 26/382; B23K 26/402; B23K 26/362; B23K 26/0093

(57) ABSTRACT

The invention relates to a method for producing plastic components for a vehicle, wherein the plastic components are at least partially painted in a painting step and are subsequently connected to further components on the non-painted surfaces, wherein at least one region, which is used to connect to the further components, is freed of impurities by a removal method using laser light.

### CROSS-REFERENCE TO RELATED APPLICATIONS

This application is a National Stage of International Application No. PCT/EP2018/081056, filed Nov. 13, 2018, which claims priority to DE 102017223376.1 filed Dec. 20, 2017 and DE 102018208715.6 filed Jun. 4, 2018. The entire disclosures of each of the above applications are incorporated herein by reference.

### FIELD OF THE INVENTION

The invention is based on a method for producing plastic components for a vehicle, the plastic components being at least partially coated in a coating step and subsequently being connected to further components on the uncoated surfaces.

The invention extends to a plastic component which is produced by the method.

The invention furthermore relates to a processing system with which the method can be carried out.

### BACKGROUND

In automobile manufacturing, large-format plastic components, or plastic assemblies, have long been used. For the bodywork, front or rear modules are in this case made from plastic, as well as doors or tailgates or even trim parts for sills or vehicle pillars.

Depending on the task of the large-format plastic components or plastic assemblies, the plastic components are connected to further components for reinforcement or for trimming or for receiving functional components.

EP 2384917 B1 discloses such a vehicle bodywork group, in which regions are provided for fastening, the component being composed of a plurality of individual structures.

If the components are used for the bodywork of the vehicle, they are generally coated in the vehicle color. The coating is carried out directly after the production of the component by plastic injection molding. During the coating of the often large-format components, coating lines are used in which robotic arms of the plastic component are held with or without a frame and are exposed to a coating spray.

In this case, it is not possible to prevent not only the visible surfaces, which are actually intended to be coated, being provided with coating, but also that rear sides or masked surfaces are also contaminated by the so-called “overspray”. This involves deposition of the coating spray on the entire component.

Since the plastic components need to be further installed and processed after the coating, this contamination by the coating is detrimental. Particularly when processing the plastic components by means of assembly methods such as welding or adhesive bonding, the coating residues are an impairment to reliable processing. In order to keep regions on the plastic components free of contaminants after the coating, during production, adhesive strips, so-called masking aids, are adhesively bonded onto the regions which are ultimately required for the further processing of the plastic component.

This masking process usually needs to be carried out manually, and the removal of the adhesive strips after the coating is also carried out manually.

For the processing of components, lasers as processing devices have long occupied an established place in many fields of industry. They have, for example, been made industrially usable over large areas in the field of surface processing on fiber composites in the last decade.

Laser processing very generally has the particular advantages that it can be carried out dry and without the use of chemical substances. It furthermore constitutes in general a clean, dust-free method of processing, in which no material damage furthermore takes place. Laser processing has low operating costs and is therefore consequently associated with high economic viability.

DE102009012858 A1 discloses CO₂ laser processing in which, by linking a robot to linear axes, the working radius of a processing device is increased with the aid of the robot. The guiding of the laser beam is carried out by means of mirrors in the working head. A light source, in particular a laser light source, is arranged on this platform and a robot unit is connected to the platform. The robot unit comprises a beam expander unit at the spatially mobile end. A beam guiding system is furthermore provided for guiding the light from the light source the beam expander unit, in particular working head. The beam guiding system contains at least one light beam emitter connected rigidly or in a mobile fashion to the platform, and at least one beam receiver connected rigidly or in a mobile fashion to the beam expander unit. The beam emitter and the beam receiver are furthermore arranged at a variable distance from one another.

Surface treatments are carried out with such an arrangement.

On the basis of this prior art, the object of the invention is to provide a method for producing plastic components which are coated, process steps being integrated with one another in a straightforward way. It is furthermore an object of the invention to produce a plastic component which is particularly simply and economically prepared for further processing.

To this end, a special processing system is used.

### SUMMARY OF THE INVENTION

This section provides a general summary of the disclosure, and is not a comprehensive disclosure of its full scope or all of its features.

The object is achieved by a method for producing plastic components for a vehicle, the plastic components being at least partially coated in a coating step and subsequently being connected to further components on the uncoated surfaces, wherein at least one region, which is used for connection to the further components, is freed of contaminants by removal method with laser light.

By using lasers to remove the contamination on the plastic components, the adhesive bonding and removal of adhesive strips and the use of human labor are obviated.

In this case, it is provided that at least the front side of the plastic component is coated, and contaminants due to overspray on the rear side or targeted regions on the front side are removed with laser light.

Advantageously, after the coating step, a processing step, in which stamping and/or boring is combined with laser ablation, is carried out.

By the integration of laser ablation into the processing step, which also means that a machine station is used for this processing step, the plastic components can be processed very efficiently. In this case, it is also conceivable for the processing steps of boring likewise to be carried out with a laser, in which case the same laser head as for the laser ablation of the overspray may be used for the boring. The use of two different laser heads, each optimized for their task, is however also conceivable.

For the method, it is furthermore advantageous that the plastic component is kept upright for the processing step. In this case, it is advantageous that it may be possible to economize on production area when the large-format plastic components are processed not horizontally but in a vertical arrangement.

In this case, it is advantageous that after the processing step, the plastic component is connected in a further combination step to further components made of plastic and/or of metal and/or of composite material in the regions for connection.

Advantageously, the regions for connection extend continuously along the plastic component contour.

The object is furthermore achieved by plastic components produced by the method, wherein the plastic components are tailgates or front modules or rear modules or sill trims of a vehicle.

The object is also achieved by a processing system, which may contain stations that are used for removing contaminants with laser light, for boring and/or stamping and for laser boring and laser cutting.

The processing system is in this case advantageously connected to a storage column for the stamping and boring tools.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 shows an example of a vehicle tailgate,

FIG. 2 schematically shows production steps,

FIG. 3 schematically shows a processing station.

### DESCRIPTION OF THE INVENTION

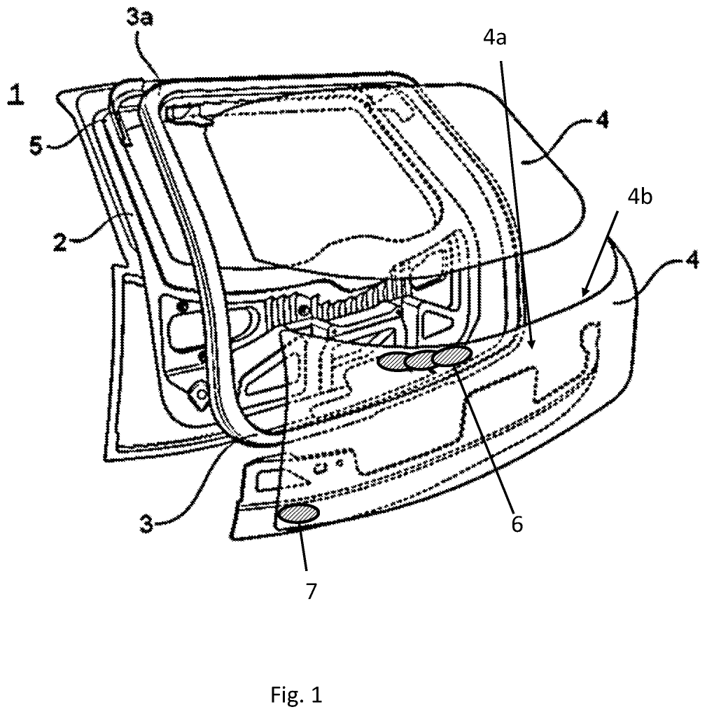

FIG. 1 represents the main parts of a tailgate 1, which is used as an example of large-area plastic components. A carrier part 2, which is made for example from fiber-reinforced plastics, is used as a base of the tailgate. The stiffening frame 3 has a closed shape or any desired unclosed shape made of a polyurethane material or other composite materials. The trim parts 4 are connected to the carrier part 2. For stiffening of the tailgate, stiffening elements 5 are provided, which in this exemplary embodiment are made from metal and are arranged in the region 3a. They are connected separately to the carrier part 2.

The trim parts 4 are in this case coated on their visible surfaces 4a. The coating may in this case naturally also include edge regions of the trim parts 4 which remain visible after assembly.

Provided on the inner side 4b of the trim parts 4, there are regions 6 which must be freed of contaminants for connection of the trim part 4 to the carrier part 2.

The trim part 4 furthermore may also comprise regions 7 that need to be prepared in order to receive sensors, and are likewise freed of contaminants.

The trim parts 4 are examples of plastic components which are mounted on the vehicle with externally visible coated surfaces.

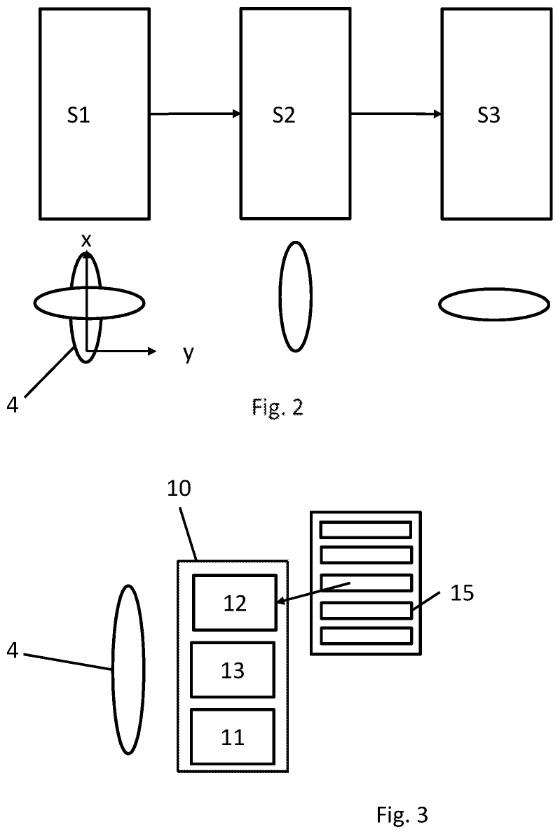

FIG. 2 schematically represents the processing method in the three main steps. The processing method is not in this case intended to be limited only to these three main steps. In a first processing step, the coating step S1, or in a first processing station, the plastic components, for example the trim parts 4, are coated. In this case, the plastic components 4, as likewise represented very schematically below the method steps, are processed in different orientations x, y, z. Particularly when using coating robots as well as robotic arms, which carry the components with or without a frame, the plastic components 4 are held and thus coated in a very wide variety of orientations.

The processing system 10 in the processing step S2 receives the coated plastic component 4 automatically or manually and contains at least one processing station 10, in which the plastic component 4 is freed of contaminants on the uncoated inner side 4b. In this case, a CO₂ laser is used in order to free regions 6, which are needed for connection of the plastic component 4 to further components, of contamination.

Furthermore, regions 7 which are intended for the mounting of functional components, for example sensors, are also freed of contamination.

In the processing step S2, further processing operations may also be provided, such boring of holes and stamping of recesses. In this case, boring of holes is also possible with a laser, in which case a single laser may be used for removal of the contaminants and for boring of the holes. As an alternative, two different lasers are used for this.

The processing system used in the processing step S2 preferably processes the plastic component 4 in the vertical direction, i.e. as indicated in FIG. 2 in an orientation along the x-axis.

This upright arrangement economizes on installation space during production. A storage column 15 for different stamping tools and/or boring tools, with which the station may be automatically equipped, may furthermore be provided in the vicinity of the processing system 10 of the processing step S2.

In this way, it is possible to process very different plastic components 4 in the processing step S2 at this station, since replacement of the tools may be carried out straightforwardly and the CO₂ laser may easily be adapted for different cleaning tasks.

In the next processing step S3, the prepared plastic component 4 is connected to further parts and further components.

The processing system 10 is likewise represented schematically in FIG. 3. The processing system 10 in this case comprises a station 11 for cleaning with laser light.

The processing system 10 furthermore contains a station for mechanical processing with stamping and/or boring tools. This station 12 has automatic access to the tools that are held in the storage column 15.

In the exemplary embodiment, the processing system 10 furthermore contains a station 13 which is configured for the laser boring or laser cutting.

The stations 11 and 13, both of which operate by using laser light, may in this case be served by a single laser head, or alternatively by 2 laser systems optimized for the respective tasks.

### LIST OF REFERENCES

1 component
2 carrier part
3 frame
3a region of the frame
4 trim part
4a visible surfaces
4b inner side
5 reinforcing part
6 regions for connection
7 regions for functions
S1, S2, S3 processing steps
10 processing system
11 station for cleaning
12 station for mechanical processing
13 station for laser boring
15 storage column

1. A method for producing plastic components for a vehicle, the plastic components being at least partially coated in a coating step and subsequently being connected to further components on the uncoated surfaces, wherein at least one region, which is used for connection to the further components, is freed of contaminants by removal method with laser light.

2. The method as claimed in claim 1, wherein at least the front side of the plastic component is coated, and contaminants due to overspray on the inner side are removed with laser light.

3. The method as claimed in claim 1, wherein after the coating step, a processing step, in which stamping and/or boring is combined with laser ablation, is carried out.

4. The method as claimed in claim 1, wherein the plastic component is kept upright for the processing step.

5. The method as claimed in claim 1, wherein after the processing step, the plastic component is connected in a further combination step to further components made of plastic and/or of metal and/or of composite material in the regions for connection.

6. The method as claimed in claim 1, wherein the regions for connection extend continuously along the plastic component con-tour.

7. The method as claimed in claim 1, wherein regions for functions are cleaned of contaminants.

8. A plastic component produced by the method as claimed in claim 1, wherein the plastic components are tailgates or front modules or rear modules or sill trims of a vehicle.

9. A processing system for a plastic component produced by a method as claimed in claim 1, wherein the processing system comprises at least one station for cleaning with laser light.

10. The processing system for a plastic component as claimed in claim 9, wherein the processing system contains a station for mechanical processing with stamping and/or boring tools.

11. The processing system for a plastic component as claimed in claim 9, wherein the processing system contains a station for laser boring.

12. The processing system for a plastic component as claimed in claim 9, wherein the station and the station have a common laser.

13. The processing system for a plastic component as claimed in claim 9, wherein the processing system can be equipped with tools from a storage column.
